(19) United States
(12) Patent Application Publication
(10) Pub. No.: US 2024/0090087 A1
(43) Pub. Date: Mar. 14, 2024

(54) HEATER AND METHOD FOR PRODUCING A HEATER

(71) Applicant: BorgWarner lnc., Auburn Hills, MI (US)

(72) Inventors: Sven Schumm, Walheim (DE); Jose Alberto Blanco Fernandez, Pontevedra (ES); Phanendra B. Devineni, Germantown, TN (US)

(21) Appl. No.: 18/512,977

(22) Filed: Nov. 17, 2023

Related U.S. Application Data
(63) Continuation of application No. PCT/US2021/035109, filed on Jun. 1, 2021.

(51) Int. Cl. H05B 3/12

(52) U.S. Cl. CPC H05B 3/12; H05B 2203/002; H05B 2203/017

(57) ABSTRACT

Disclosed is a heater comprising a metal substrate, a dielectric layer arranged the substrate, and resistive tracks arranged on the dielectric layer, wherein the resistive tracks comprise at least 60% iron, and at least 10% chromium. Also disclosed is a method for manufacturing such a heater.

### RELATED APPLICATIONS

This application is a continuation of and claims priority to International Application Serial No. PCT/US2021/035109, filed Jun. 1, 2021, the entire disclosure of which is hereby incorporated herein by reference.

### BACKGROUND

This disclosure refers to a heater having a metal substrate, a dielectric layer arranged on the substrate, and resistive tracks arranged on the dielectric layer. Such heaters are electrical resistance heaters and are sometimes called “layered heaters,” as they contain layers of different materials. Layered heaters are generally disclosed in U.S. Pat. No. 8,680,443 B2.

Layered heaters can be produced by different methods. For example, layers may be printed, produced by ion plating, chemical vapor deposition, physical vapor deposition or thermal spraying.

### SUMMARY

This disclosure teaches a heater that can be produced at low cost and allows efficient transfer of heat produced by the resistive tracks via the substrate to a fluid to be heated.

This object is met with a heater according to claim 1 as well as a method for producing such a heater. Advantageous refinements of the invention are the matter of dependent claims.

The resistive tracks of a heater according to this disclosure comprise at least 60% iron, e.g., 70% iron or more, and at least 10% chromium, e.g., 15% chromium or more. These percentages and all percentages stated in the following are by weight.

As the resistive tracks of a heater according to this disclosure are an iron based material, there is a significant cost advantage compared to commonly used resistor materials made of nickel and chromium as disclosed in US 2019/0289674. A heater according to this disclosure may be produced with a bonding layer arranged between the dielectric layer and the substrate by thermal spraying of a dielectric layer and resistive tracks, for example by flame spraying, wire arc spraying, APS (Atmospheric Plasma Spray), and HVOF (High Velocity Oxygen Fuel), among others.

The chromium content of the resistive tracks is important for avoiding large variations of resistivity, presumably by controlling oxidation. A chromium content of more than 30% offers no additional advantage in that respect. Good results have been achieved with resistive tracks that contain up to 25% chromium. Resistive tracks having 15% chromium or more, show smaller manufacturing tolerances regarding resistivity than resistive tracks that comprise less chromium. Excellent results have been achieved with resistive tracks having 19% to 25% chromium.

The inventors have found that the resistive tracks can be improved by the addition of aluminum. For example, the resistive tracks may contain 2% aluminum or more, for example 3% or more. It is believed that an aluminum content of more than 10% offers no additional benefit. Good results can be achieved with resistive tracks comprising not more than 7% aluminum, e.g., 4% to 6% aluminum.

The resistivity of the resistive tracks may be increased and better controlled by the addition of silicon, yttrium and/or manganese. For example, the resistive tracks may contain 0.5% or more of silicon, yttrium and/or manganese. Good results have been achieved with resistive tracks containing 0.5% to 3% of silicon, yttrium and/or manganese. As silicon, yttrium and manganese additions to the resistive tracks have similar effects, the resistive tracks may contain 0.5% to 3% of a mixture of silicon, yttrium and manganese or 0.5% to 3% silicon, or 0.5% to 3% yttrium or 0.5% to 3% manganese.

According to a refinement of this disclosure, the substrate is made of aluminum or an aluminum based alloy. For example, the substrate may have an aluminum content of 95% or, especially of 98% or more. Such a substrate has excellent thermal conductivity. In another embodiment of this disclosure, the substrate may be stainless steel, e.g., ferritic or austenitic steel.

According to another refinement of this disclosure, the dielectric layer is made of aluminum oxide. No high purity is necessary. For example, the dielectric layer may have an aluminum oxide content of 97% or more.

The substrate, the dielectric layer and the resistive tracks may have different coefficients of thermal expansion. This may cause mechanical strain and even damages when the heater is operated at elevated temperature. Such strains may be distributed more evenly across a wide temperature range and lowered considerably if the substrate is heated before thermal spraying, e.g., to a temperature of 150° C. or more. Moreover, strains and/or damages resulting therefrom may also be reduced by a bonding layer arranged between the dielectric layer and the substrate. The bonding layer may for example be made of a nickel based alloy, for example a nickel-chromium alloy, e.g., 80Ni-20Cr.

According to another refinement of this disclosure, the bonding layer may have a thickness of 20 μm or more. A thickness of more than 35 μm usually offers no additional benefit.

The resistive tracks of a heater according to this disclosure may include other elements in addition to iron, chromium, aluminum, silicon, yttrium and/or manganese. The total of these other elements may be up to 10%, for example 5% or less. In some embodiments of this disclosure the resistive tracks may have up to 2% of elements that are different from iron, chromium, aluminum, silicon, yttrium and manganese, for example up to 1% of elements that are different from iron, chromium, aluminum, silicon, yttrium and manganese.

According to another refinement of this disclosure, the resistive layer may comprise less than 5% of elements that are different from Iron, chromium and aluminum, for example less than 3% of elements that are different from Iron, chromium and aluminum.

According to another refinement of this disclosure, the resistive layer may comprise up to 1% impurities. The composition of the resistive tracks has been specified for various embodiments of this disclosure by given minimum amounts or percentage ranges of various elements. As far as the minimum amounts or ranges do not add up to 100%, any remainder may be iron.

According to another refinement of this disclosure, the resistive tracks and the dielectric layer are covered by a cover layer. The cover layer protects the dielectric layer and can avoid microcracking. Especially if the dielectric layer is alumina, properties of the dielectric layer can be improved by a cover layer. The cover layer may be made of silicon oxide that may or may not contain some impurities, e.g., up to 5% impurities. The cover layer may comprise 96% silicon oxide or more, e.g., 98% silicon oxide or more. The cover layer itself may be covered by yet another layer, e.g., another electrically insulating layer, especially a glass layer.

### BRIEF DESCRIPTION OF THE DRAWING

The above-mentioned aspects of exemplary embodiments will become more apparent and will be better understood by reference to the following description of the embodiments taken in conjunction with the accompanying drawings, wherein:

FIG. 1 schematically shows a sectional view of an embodiment of a heater according to this disclosure.

### DESCRIPTION

The embodiments described below are not intended to be exhaustive or to limit the invention to the precise forms disclosed in the following description. Rather, the embodiments are chosen and described so that others skilled in the art may appreciate and understand the principles and practices of this disclosure.

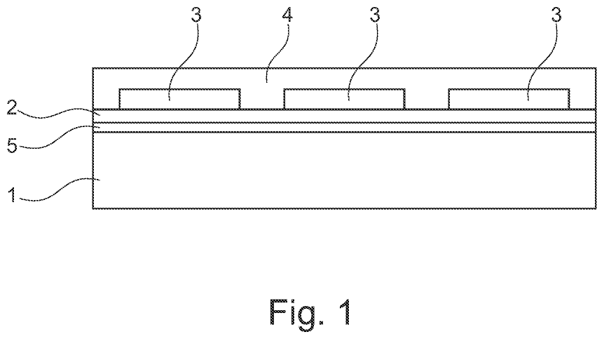

FIG. 1 schematically shows and not to scale a sectional view of a heater with a substrate 1, a dielectric layer 2, resistive tracks 3, a cover layer 4, and a bonding layer 5.

The substrate 1 is made of metal, for example, aluminum or an aluminum based alloy. Although the substrate 1 is shown in FIG. 1 as a flat sheet, the substrate 1 may also have curved shape, and be for example a tube.

The dielectric layer 2 arranged on the substrate 1 is electrically insulating and can be produced by thermal spraying, for example. The necessary thickness of the dielectric layer 2 depends on the required breakdown strength and thus on the electrical voltage that is applied to the resistive tracks when the heater is in operation. In general, a thickness of at least 0.15 mm is advantageous. For example, a thickness in the range of 0.25 mm to 0.5 mm usually gives good results. As the dielectric layer 2 impedes thermal flow from the resistive tracks 3 to the substrate, the dielectric layer 2 should not be too large.

The material of the dielectric layer 2 may be an insulating ceramic material, for example alumina or an alumina-based oxide. Purity of the alumina is not critical. For example, the cover layer 2 may contain 95% aluminum oxide or more, especially 99% aluminum oxide or more. Adhesion of the dielectric layer 2 to the substrate 1 may be improved by spraying the dielectric layer 2 onto a heated substrate 1, especially a substrate heated to a temperate of at least 150° C., for example a temperature in the range of 150° C. to 300° C.

Adherence of the dielectric layer 2 to the substrate 1 may be improved by a bonding layer 5 arranged between the dielectric layer 2 and the substrate 1. The material of the bonding layer 5 may be a nickel-based alloy, for example a nickel-chrome alloy. Good results have been achieved with a bonding layer 5 made of Ni80Cr20, for example.

Adherence of the dielectric layer 2 may also be improved by surface activation or preparation before the dielectric layer 2 and/or the bonding layer 5 is applied.

The resistive tracks 3 are made of an iron based chromium alloy and may be produced by thermal spraying. The iron content is at least 60%. The chromium content of the resistive tracks 3 is at least 10%, for example 15% or more. A chromium content above 30% has no additional benefits. In the embodiment shown, the chromium content is in the range of 18% to 25%.

The resistive tracks 3 also contain aluminum, for example. The aluminum content of the resistive tracks 3 is lower than the chromium content, but at least 2%, for example 3% or more. At most, the aluminum content is 10%. In the embodiment shown, the aluminum content of the resistive tracks 3 is in the range of 4% to 6%.

The restive tracks 3 may also contain additional elements in order to improve corrosion resistance. Suitable for reducing oxidation are especially yttrium, silicon, and manganese in an amount of at least 0.5% total. Yttrium, silicon and manganese are largely interchangeable for reducing oxidation. Hence, the above state total of 0.5% may be a mixture of Yttrium, silicon and manganese or it may be only yttrium, only silicon or only manganese, for example. The total amount of such additional elements added to prevent oxidation is usually less than 3%, for example 1% to 2%.

The resistive tracks 3 may also contain impurities. The total amount of impurities is usually at most 1%, for example about 0.5%. Any remaining content of the resistive tracks 3 that is not explicitly specified by the above explanation is iron.

The resistive tracks 3 are covered by a cover layer 4 that seals the resistive tracks 3 between itself and the dielectric layer 2. The cover layer may be an amorphous layer (i.e., a glass layer), for example based on silicon oxide. The purity of the silicon oxide of the cover layer 4 is not critical. For example, the cover layer 4 may comprise 95% silicon oxide or more.

While exemplary embodiments have been disclosed hereinabove, the present invention is not limited to the disclosed embodiments. Instead, this application is intended to cover any variations, uses, or adaptations of this disclosure using its general principles. Further, this application is intended to cover such departures from the present disclosure as come within known or customary practice in the art to which this invention pertains and which fall within the limits of the appended claims.

### LIST OF REFERENCE SIGNS

1 substrate
2 dielectric layer
3 resistive tracks
4 cover layer
5 bonding layer

What is claimed is:

1. A heater, comprising:
a metal substrate;
a dielectric layer arranged on the substrate; and
resistive tracks arranged on the dielectric layer, wherein the resistive tracks comprise at least 60% iron and at least 10% chromium.

2. The heater according to claim 1, wherein the resistive tracks comprise at most 30% chromium.

3. The heater according to claim 1, wherein the resistive tracks comprise at least 15% chromium.

4. The heater according to claim 1, wherein the resistive tracks comprise at least 2% aluminum.

5. The heater according to claim 1, wherein the resistive tracks comprise at most 10% aluminum.

6. The heater according to claim 1, wherein the resistive tracks comprise at least 3% aluminum.

7. The heater according to claim 1, wherein the resistive tracks comprise 0.5 to 3% silicon, yttrium and/or manganese.

8. The heater according to claim 1, wherein the dielectric layer comprises at least 95% aluminum oxide.

9. The heater according to claim 1, wherein the metal substrate is made of aluminum or an aluminum based alloy.

10. The heater according to claim 1, wherein the resistive tracks are covered by an electrically insulating cover layer.

11. The heater according to claim 10, wherein the cover layer is made of silicon oxide.

12. The heater according to claim 1, wherein the dielectric layer has a thickness of at least 0.25 mm.

13. The heater according to claim 1, wherein a bonding layer is arranged between the dielectric layer and the substrate.

14. Method for producing a heater, comprising:
providing a metal substrate;
covering the metal substrate with a dielectric layer by means of thermal spraying; and
creating resistive tracks on the dielectric layer by thermal spraying, wherein the resistive tracks comprise at least 60% iron and at least 10% chromium.

15. The method according to claim 14, wherein the substrate is heated to a temperature of at least 150° C. before thermal spraying of the dielectric layer.
